(19) United States
(12) Patent Application Publication
(10) Pub. No.: US 2009/0192851 A1
(43) Pub. Date: Jul. 30, 2009

(54) Location-Based Transportation Management

(76) Inventor: Paul L. Bishop, Redwood City, CA (US)

Correspondence Address: FISH & RICHARDSON P.C., PO BOX 1022, MINNEAPOLIS, MN, 55440-1022, US

(21) Appl. No.: 12/359,708

(22) Filed: Jan. 26, 2009

Related U.S. Application Data
(60) Provisional application No. 61/023,759, filed on Jan. 25, 2008.

(51) Int. Cl. G06Q 10/00

(52) U.S. Cl. 705/7; 705/1

(57) ABSTRACT

Various implementations of a location based transportation management system and methods are disclosed, including a device for visually communicating with drivers in a variety of environments.

### RELATED APPLICATION

This application claims the benefit of priority from Provisional Application No. 61/023,759, for “Location-Based Transportation Management”, filed Jan. 25, 2008, which provisional application is incorporated by reference herein in its entirety.

### TECHNICAL FIELD

The subject matter of this patent application is generally related to mobile devices, transportation systems and location-based services.

### BACKGROUND

Modern transportation systems (e.g., taxi services) are deficient in a variety of ways. In a typical scenario, potential customers compete for taxi services on street corners in cities around the world. Often, more timid individuals lose out to more aggressive individuals in the contest to “hail” a taxi. For example, it may be difficult for shorter individuals to be seen by taxi drivers on a busy street corner, or a timid individual may be forced away from the corner by more aggressive customers.

Inefficient dispatching of taxis is another problem plaguing taxi services. Thousands of gallons of fuel are wasted by taxis cruising areas where there are few potential customers. Fuel is also wasted by taxi drivers taking longer routes than necessary to carry passengers to their destinations. Some taxi services have installed Global Positioning System (GPS) receivers in their taxi cabs to help drivers find destinations and to track taxis for dispatching. Such GPS systems, however, only provide taxi drivers with their locations and not the locations of potential customers, which can change based on a variety of reasons, such as sporting events, concerts, seasons, conferences, etc.

Another problem with modern taxi service is price gouging. Many customers are ripped off by dishonest taxi drivers who overcharge, take longer routes, tamper with their meters, and use other tactics to increase fares.

Yet another problem with modern taxi services is there is no clear way for taxi services to build customer loyalty or a brand name. Most customers do not distinguish between different taxi services and will simply use whatever taxi services is available at the moment of need. Thus taxi services have to compete over and over for potential customers on every street corner. Although taxi services can offer coupons and other advertised discounts, the benefits of such discounts are difficult and costly to deploy, track and manage. The failure to capture a loyal customer base also results in lost revenue opportunities that can be obtained from third party advertising and services.

### SUMMARY

The deficiencies described above are addressed by various implementations of a location based transportation management system and methods, as well as a device for visually communicating with drivers in a variety of environments, referred to herein as a “whip.”

A customer can request transportation services from one or more transportation service providers using a device which can be coupled to a “whip.” The “whip” can include an extendable (e.g., telescoping) portion which can be illuminated with one or more colors for visually communicating with drivers in variety of environments.

The request can be wirelessly transmitted to one or more providers. The request can include and/or be associated with first information (e.g., device location, destination, device ID) for determining second information related to the requested transportation services. The second information can include a route and one or more bids or estimated fares generated by the one or more transportation service providers. If bids are provided, the customer can accept a bid and a driver associated with the accepted bid can confirm that the services will be rendered for the agreed upon bid or fare price. These features can help reduce price gouging by drivers. These features can also allow providers to build a loyal customer base and brand name through a subscription service that allows customers to set up and fund accounts for electronic fare payments directly from their devices. Providers can also use the subscription service to provide personalized transportation services to subscribers, and to create alternative revenue streams with third parties who may wish to advertise or provide content to customers on websites, on display devices in vehicles or through other channels.

Traffic management data can be aggregated by transportation service providers and used to manage fleets. For example, traffic management data can be used to reduce costs (e.g., fuel costs) by identifying patterns (e.g., customer usage patterns, traffic patterns) in real time that can be used to efficiently dispatch vehicles to locations having high concentrations of potential customers.

The location-based traffic management system described above provides numerous advantages for transportation service providers, customers and government agencies (e.g., metropolitan transit authorities). In its various implementation, the system can: 1) act as a matchmaker for customers and drivers, 2) allow transportation service providers and/or transportation authorities to gauge customer usage patterns, traffic patterns and/or revenue, to efficiently dispatch drivers, to save fuel costs and to make forecasts (e.g., determining the number of taxi cabs to purchase), 3) provide an automated alert to customers (e.g., including disabled customers) when their transportation has arrived or will soon arrive, 4) allow customers to select a particular driver or specify other preferences for personalized service, 5) allow for electronic debit of fares which can reduce the risk that a driver will not paid and/or that the customer is not carrying enough cash, 6) allow transportation service providers to build a loyal customer base and brand name through a subscription service other service model, 7) provide a bidding system where independent drivers and/or companies can bid on fares, 8) monitor and track abuse and criminal events (e.g., price gouging), and 9) provide customers with a portable device, or an attachment to a portable device, for safely and effectively hailing transportation under a variety of adverse environments (e.g., night).

### DESCRIPTION OF DRAWINGS

FIG. 1A is a schematic diagram of an example device for communicating with transportation services.

FIG. 1B is a schematic diagram of another example device for communicating with transportations services.

FIG. 2 is a flow diagram of an example process for communicating with transportation services.

FIG. 3 is a block diagram of an example network operating environment for the devices of FIG. 1.

FIG. 4 is a flow diagram of an example process performed by a transportation service for matching customers with available transportation.

FIG. 5 illustrates an example display presented to a customer in accordance with the process of FIG. 2.

FIG. 6 illustrates an example display presented to a driver in accordance with the process of FIG. 4.

FIG. 7 is a schematic diagram of an example mobile device for performing the process of FIG. 2.

### DETAILED DESCRIPTION

### Example Devices

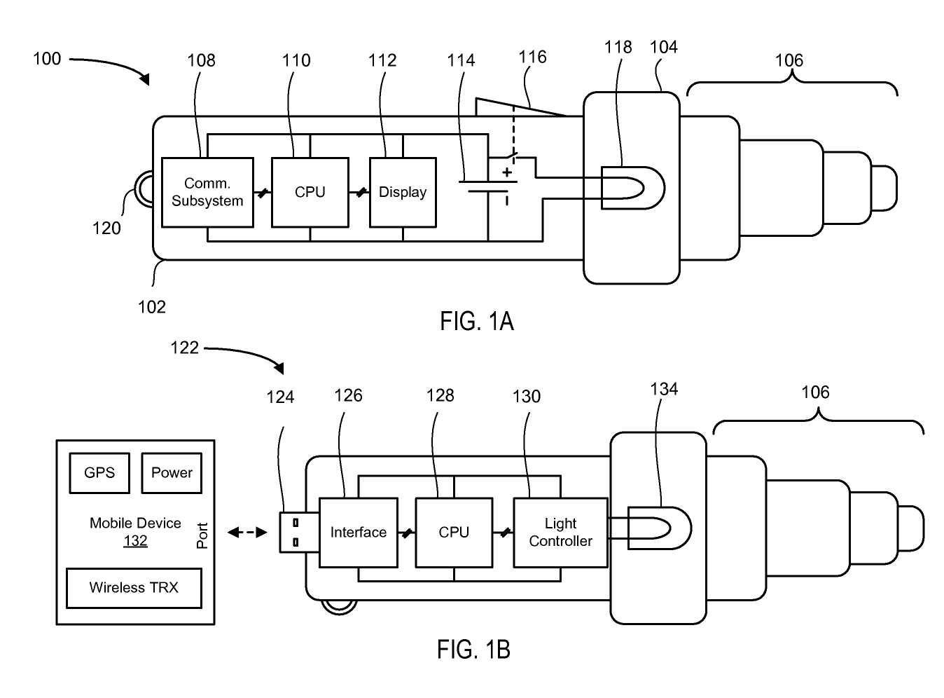

FIG. 1A is a schematic diagram of an example device 100 for communicating with transportation services. In some implementations, the device 100 can include a housing 102, a light module 104, an extendable portion 106, a communication subsystem 108, a processor 110, a display 112, a power source 114, a switch 116 and an illuminating device 118.

In some implementations, the extendable portion 106 is telescoping and can be manually extended by a customer. The extendable portion 106 can be made of extruded plastic, metal or any other suitable material. The extendable portion 106 can be secured to, or form part of, the light module 104. The extendable portion 106 can be made with colored or translucent plastic. In one implementation, the extendable portion can be a translucent plastic tube which can contain chemical substances capable of producing light through a chemical reaction induced chemoluminescence. The extendable portion 106 can be cylindrical, rectangle or any other desired shape. The extendable portion 106 can extend to any desired length (e.g., one or two feet) In the text that follows, the extendable portion 106 is also referred to as a “whip” or “taxi whip.”

The light module 104 houses one or more illuminating devices 118 which can be any device capable of providing electromagnetic radiation, such as a light bulb (e.g., incandescent, fluorescent) or Light Emitting Diode (LED). The light module 118 can include, or be configured to receive, one or more colored lens for providing colored light which can change the perceived color of the extendable portion 106.

The housing 102 can be any size or shape but is preferably compact so that it can be worn or carried by a customer. For example, the housing 102 can be the same size and shape as a typical pen flashlight. The housing 102 can include a hook or latching mechanism for attaching a strap or keychain. The housing 102 can include a clip to allow the device 100 to be worn by a customer. In one implementation, the device 102 can have the same size and form factor as a Universal Serial Bus (USB) thumb drive.

The power source 114 can be a battery which can be electrically connected to the illuminating device 118 by the switch 116 (e.g., a mechanical button). Thus the customer can use the switch 118 to turn the illuminating device 118 on and off in a manner similar to a common flashlight. In some implementations, the switch 118 also connects the power source 114 to a Printed Circuit Board (PCB) to power components 108, 110 and 112.

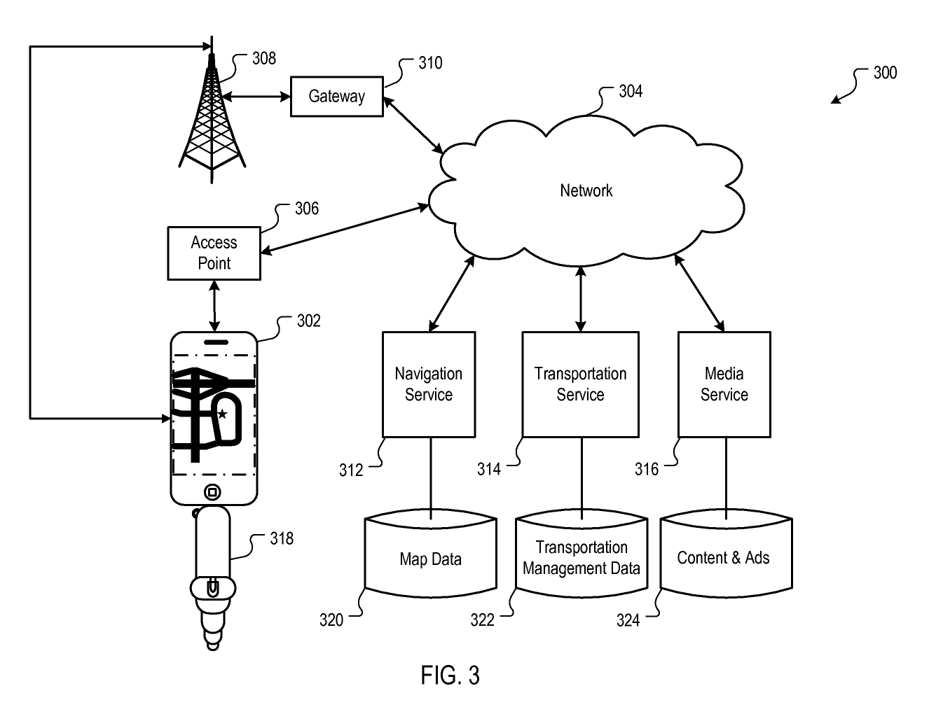

In some implementations, the housing 102 can be adapted to hold the PCB for supporting the components 108, 110 and 112. The communication subsystem 108 can include one or more integrated circuit chips or a single chip (e.g., a system on chip (SoC)). In one configuration, the communication subsystem 108 can include positioning technology, such as a GPS receiver. The communication subsystem 108 can also include a wireless transceiver chip for providing wireless access to a network using any suitable wireless technology (e.g., cellular, Wi-Fi). The positioning technology allows the device 100 to be “location aware” and the wireless transceiver allows the device 100 to communicate its location and other information to a network operating environment 300, as described in reference to FIG. 3. The wireless transceiver also allows the device 100 to receive information from the network operating environment 300, and optionally display the information on display 112. The display 112 can be an LED or Liquid Crystal Display (LCD), for example.

The device 100 can include a processor 110 which can execute software or firmware instructions stored in memory (not shown) for providing various processing functions and for running applications. For example, the processor 110 can receive and process information received by the communication subsystem 108 for presentation on the display 112. The display 112 can be a touch sensitive display for receiving touch input.

FIG. 1B is a schematic diagram of another example device 122 for communicating with transportations services. The device 122 is designed to couple to a host device 132, such as a mobile phone, media player, email device, personal computer, game console, etc. The device 122 differs from the device 100 in that it can receive power from the host device 132. The device 122 can include a connector 124 and interface 126 having circuitry (e.g., voltage divider, buffers, latches) for facilitating connection and interoperation with the host device 132.

In addition to providing power, the host device 132 can also provide a communication subsystem, including positioning technology and wireless technology. In the example, shown the device 122 is USB device which can plug into a USB port on the host device and receive power and signals or data from the host device.

In some implementations, the device 122 can include a light controller 130 which can include, for example, an array of different colored illuminating devices 134 (e.g., an array of LEDs) which can be programmatically controlled by a processor 128 or manually by the customer, so that the extendable portion 106 can be illuminated in different colors.

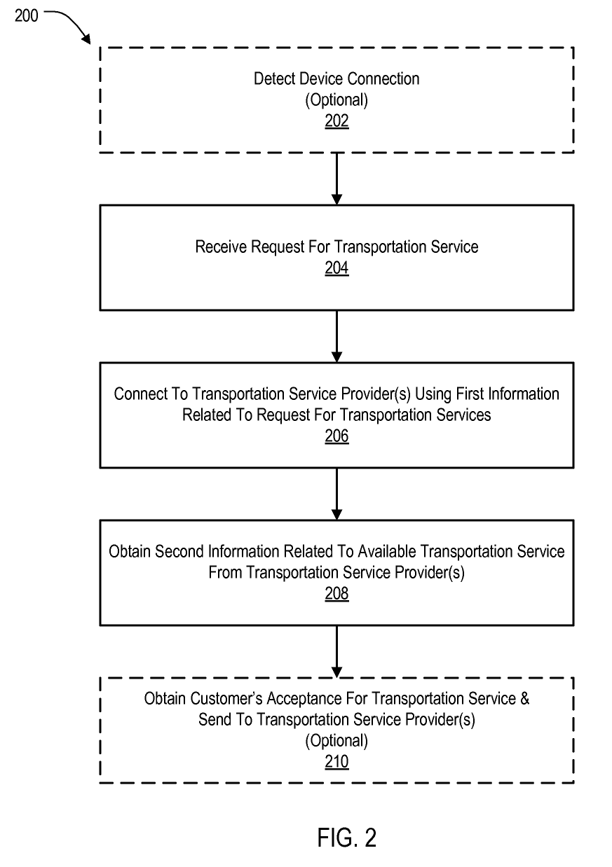

In operation, a customer can use the devices 100, 122 to hail transportation by providing visual signals to drivers. For example, a customer waiting for a taxi on a busy street corner can attach device 122 to the host device 132 (e.g., the customers smart phone) using a USB connector 124. The customer can manually adjust the extendable portion 106 so that it creates a “whip” which can be held (or waived) like a sign above the crowd so that it can be easily seen by a taxi driver. The light controller 130 can be operable to change the color of the “whip” to communicate with taxi drivers, as will be described in reference to FIGS. 2-6. For example, the color yellow could signal to drivers of Yellow Cab company, the color blue could signal to drivers of Blue Cab company, etc.

In some implementations, the devices 100, 122 can emit a noise or other audio signal (e.g., ringtone, song) to alert the customer when the vehicle is within a predetermined distance (e.g., within a predetermined radius) of the pick-up location.

In some implementations, the devices 100, 122 can include a vibrating component or other mechanism for providing force feedback to customers when the vehicle is within a predetermine distance of the pick-up location.

It should be apparent that other configurations of devices 100 and 122 are possible. For example, the extendable portion 106 can be replaced with a plastic tube of fixed length that is not extendable. Also, the components 108, 110, 112 can be implemented on one or more chips. The display 112 can be optional on device 100 and included on device 122. Note that a display 112 may not be needed on device 122 if the host device 132 includes a display.

The devices 100 and 122 are advantageous to a customer in that the devices 110, 122 are portable, “location aware” devices that can be easily carried or worn by customers, and that can be configured to visually communicate with drivers of vehicles (e.g., taxis, buses, shuttles, limousines, trains). Thus customers of small stature or that are physically limited (e.g., wheelchair bound), or that are simply overshadowed by aggressive customers when competing for transportation services, can use the devices 100, 122 to compete for transportation services in a variety of environmental conditions (e.g., crowds, night, fog, rain).

Another advantage provided by the devices 100 and 122 is the ability to communicate the customer's current location and other information (e.g., destination) to a transportation service provider and to receive information from a transportation service provider. The received information can include a map showing a route to the destination and placemarks on the map indicating the customer's current location and the location of available transportation in proximity to the customer. This particular advantage is described in more detail in reference to FIGS. 2-6.

In some implementations, the devices 100, 122 can communicate a signal to drivers and/or transportation service providers that indicates a particular physical disability of a customer so that an appropriately equipped vehicle is dispatched. For example, the signal could indicate whether a vision impaired customer has a dog or a physically challenged customer is wheelchair bound and needs a vehicle with a wheelchair lift.

In some implementations, a business (e.g., a hotel, restaurant, medical facility, entertainment facilities, concert/sports arenas, ball parks) can have a devices 100 or 122 to communicate with drivers and/or transportation service providers to indicate a number of vehicles that will be needed or a number of passengers that will need a ride. This feature could potentially eliminate the “Doorman's whistle” which adds to noise pollution on busy city streets.

In some implementations, the devices 100, 122 can be integrated into other devices or equipment. For example, the device 100 can integrated into a walking cane, umbrella handle, flashlight, pen and any other suitable article.

### Example Process for Communicating with Transportation Services

FIG. 2 is a flow diagram of an example process 200 for communicating with transportation services. The process 200 can be performed on device 100, device 122 coupled to device 122, the mobile device 132 by itself or any device with network connectivity.

In some implementations, the process 200 begins by optionally detecting a device connection (202). For example, this step can occur in the case where the mobile device 132 is coupled with the device 122, as shown in FIG. 1B. The detection can be a trigger event for placing the device into a transportation management mode. For example, the device can detect a change in electrical characteristics at a port (e.g., USB port) and/or can receive a signal from the device. The change in electrical characteristics and/or signal can be indicative of a transportation management mode. A transportation management mode can be implemented by a software application running on the device, for example. The application can provide a Graphical Customer Interface (GUI) for allowing a customer to enter information, such as a destination.

When in transportation management mode, the device 132 can receive a request for transportation service (204). For example, the user can make a request through a GUI or other input mechanism on the device. Alternatively, the request can be made automatically in response to a trigger event, such as when the device 122 is coupled to the mobile device 132 or when the device is powered up. In addition to receiving the request, the device can obtain information related to the request. The information can include an ID (e.g., a customer ID, MSID, SIM SN, ICC-ID), position information, destination information, password, encryption key, and any other information that can be used by the transportation service to deliver services to customers. For example, the mobile device 132 can obtain a device ID (e.g., a unique integer) from the device 122 and position information from a communication subsystem (e.g., communication subsystem 108). The destination and other information can be obtained through a GUI presented on a display of the device.

In some implementations, the device can connect to one or more network-based services (e.g., Internet or Web based services) using the information received in the previous step (206). The connection can be made using known communication technology. Some example technology and protocols include but are not limited to: HTTP, TCP/IP, Java, HTML, XML, SSL, etc. An ID associated with the device (e.g., MSID), a carrier or the user (e.g., ICCD-ID, SIM SN) can be used to establish connectivity with one or more of the services. In some implementations, the ID can be used by one or more of the services to authenticate the device and/or customer. Other security measures can be implemented as well (e.g., password protection, symmetric key encryption, elliptic encryption). Once connected and authenticated, the ID can be associated with other customer information (e.g., account number, account balance, preferences, personal information, customer status) stored remotely in a data repository that is accessible by the transportation service provider and/or driver.

In some implementations, the vehicle can include a terminal (e.g., a navigation system, metering system) for coupling to and communicating with the mobile device 132. For example, the customer or driver can plug the mobile device 132 into a port (e.g., a USB port) on the terminal or couple the mobile device 132 wirelessly to the terminal using BluetoothM or any other known communication technology. Once coupled to the system, the mobile device 132 can transmit any desired information to the terminal that can be used by the driver and/or a transportation service provider (e.g., customer ID, credit card number). In some implementations, the interface can provide quick payment service (QPS) or can be an electronic payment system (EPS) which can use infrared (IR) or radio frequency identification (RFID) technologies to communicate with, and receive information from, the mobile device 132 (e.g., a mobile phone, PDA, key fob).

IR-enabled mobile devices can store customers account and credit card information. When the customer signs up for transportation services (e.g., at retail location or online website of a provider), the customer provides their account information and selects a personal identification number (PIN). When the customer is ready to purchase transportation services at the point of purchase (in the vehicle), the customer's can point their mobile device at an IR reader and enter their PIN code. The mobile device can then beam encrypted information to the terminal, which then forwards information about the transaction quickly and safely to the customer's account held by the transportation service provider.

The customer receives both digital and hard-copy receipts from the IR device. The digital receipt can be downloaded into an expense report, a relief for any business traveler who has to keep track of his or her paper receipts. Installation is relatively inexpensive for the merchant—about $100 for an infrared transceiver. Customers must first purchase a PDA with the appropriate software, but benefits include the convenience of making a purchase with the same device with which they conduct business and store their personal information—no searching for credit cards.

RFID-enabled mobile devices can include an antenna and a computer chip. For example, an RFID key fob can function like an automobile's remote entry, which also uses a radio signal from a key fob. RFID technology can less expensive and less complex technology than IR because RFID does not require the customer to create a PIN or purchase a mobile device. And, key fobs can be activated from as far away as 30 feet. At a cost of $2 to $3 each, key fobs are the least expensive part of an RFID system. However, the driver or business (e.g., hotel restaurant) will need to install reader hardware which can be expensive.

To use RFID, in some implementations, a customer registers with the transportation service provider, or affiliate or agent, and receives a key fob. At the point of purchase, the customer points the key fob at an RFID transponder in the vehicle or business, which forwards encrypted data or the customer ID for a match with a repository of customer IDs. The customer's information can be verified safely, and his or her account can be charged. There is no exchange of credit card or check information, which could result in unauthorized use.

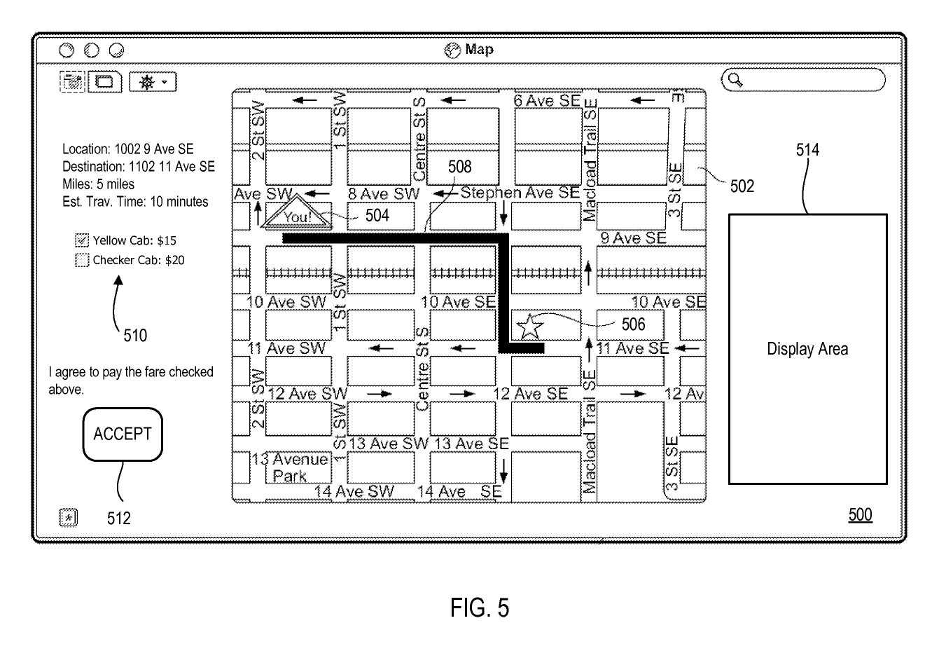

Once communication with a transportation service is established, in some implementations the device can obtain a route to the destination, an estimated travel time, one or more bids or fare estimate and any other desired information from the one or more services (208). For example, a navigation or transportation service can compute a route and generate a map with placemarks (e.g., a pushpins) showing the route, the current geolocation of the mobile device 132 and the destination, as described in reference to FIG. 5. The map can be generated using map data provided to the device by a network-based map service through an Application Programming Interface (API). An example map API is the Google® Map API provided by Google Inc. (Mountain View, Calif.).

In some implementations, the map can be displayed on a screen (e.g., a touch screen) of the device, allowing the customer to specify their current geolocation or a destination by touching (e.g., tapping) a location on the map. Alternatively, the use can enter a current geolocation and destination by entering an address in a text box. The estimated travel time, bids, fare estimates and any other desired information can be presented on the GUI or in a separate pane or user interface. For example, the estimated travel time, bids and other information can be presented in a balloon proximate the route. The balloon can be triggered in response to touch input or other input (e.g., mouse rollover, finger gesture).

In some implementations, the customer can receive bids from competing transportation service providers (e.g., taxi companies). The customer can accept a bid by touching or selecting an acceptance button or other customer interface element, and the bid acceptance is transmitted to the winning transportation service (210). In some implementations, the losing transportation service providers are also notified that their bid was not accepted. In some implementations, a time window (e.g., 5 minutes) can be established for receiving a customer acceptance. After the window expires the bids can be automatically withdrawn.

In some implementations, a single transportation service can act as a clearing house for a number of transportation service providers for a particular geographic region, or each transportation service provider can operate their own service and communicate directly with the customer through the device.

### Example Network Operating Environment

FIG. 3 is a block diagram of an example network operating environment 300 for the devices 100, 122, 132 of FIG. 1. In some implementations, the operating environment 300 can include a device 302 coupled to one or more services 312, 314, 316 through one or more networks 304 (e.g., Internet, Wi-Fi, WLAN, cellular, PSTN, satellite). The device 302 can be any device capable of connecting to a network including device 100, device 122 coupled to mobile device 132 and mobile device 132 by itself. Example devices 302 can include mobile phones, smart phones, media players, personal computers, wearable items, game devices, email devices, eTablets, ebook readers, etc. In some implementations, the device 302 can access the services 312, 314, 316 through a cellular network 308 and gateway 310. In other implementations, the device 302 can access the services 312, 314, 316 through a wireless access point 306 (e.g., Wi-Fi, WiMAX, DSL, cable, POTs).

The navigation service 312 can be coupled to a map database 320 for providing map data and other geolocation information (e.g., landmarks, gas stations, businesses) for displaying maps on device 302. The transportation service 314 can be coupled to a transportation management database 322 for providing transportation information to device 302 and to drivers (e.g., taxi drivers, shuttle or bus drivers).

The transportation management database 322 can include historical information that can be used by a transportation service provider or other entity (e.g., a government agency) to identify customer distribution patterns (e.g. locations with a need for taxi services), traffic patterns to improve route planning (e.g., identify bottlenecks and alternate routes), improve travel time estimates and to manage fraud, theft and abuse by drivers, track personal articles left in vehicles, customer travel and usage history, etc. In some cases, transportation service providers can use historical patterns to reduce fuel consumption across their fleet of vehicles. Such fuel savings can allow transportation service providers to apply for energy tax credits and other incentives offered by government agencies. A video camera mounted in the vehicle can provide video information that can be used for security purposes. Customers and/or employers of customers can request access to travel and usage history for preparing expense reports, planning future trip itineraries, preparing travel budgets, etc.

The transportation management database 322 can also include subscriber data. For example, the transportation service 314 can allow customers to subscribe to their service through a website or other customer facing interface and to allow the customer to enter personal information. For example, the customer can set-up and electronically fund an account for automatic fare deductions. This feature would allow customers to pay fares electronically. Thus the common scenario where the customer does not have enough cash for a fare is resolved.

Having customers subscribe to transportation services opens a variety of revenue opportunities. Since the ID (FIG. 2) allows transportation service providers to know the identity of subscribers in realtime (e.g., while the subscriber is traveling in their taxi cab to a destination), the transportation service provider can bombard the subscriber with content on a computer monitor or television screen in the vehicle. This information can include advertisements, discount coupons and third party offers. The service provider can sale ad space on the screen to advertisers through an auction or other advertising or revenue sharing program, such as Google Inc.'s AdWord® or AdSense® programs. In some implementations, the content or advertisements can be provide by a media service 316 (e.g., Google®, Yahoo!® Publisher Network) which can store ad inventory and content in a database 324.

Personal information provided by a customer can include customer preferences which can be used to improve customer service. For example, a customer may specify a preference for a certain type of vehicle (e.g., a taxi, limousine, shuttle) or other preferences, such as no smoking cars, music type, etc. Thus for the first time in history, transportation service providers can build a loyal subscriber base and brand name by providing personalized service to customers. Subscribers can be assigned to classes based on service usage patterns in a manner similar to airline frequent flyer programs (e.g., Premier, Business).

In some implementations, the historical information can be used by government agencies for planning or other purposes (e.g., building or widening roads, planning growth of public transportation systems).

### Example Process Performed by Transportation Service

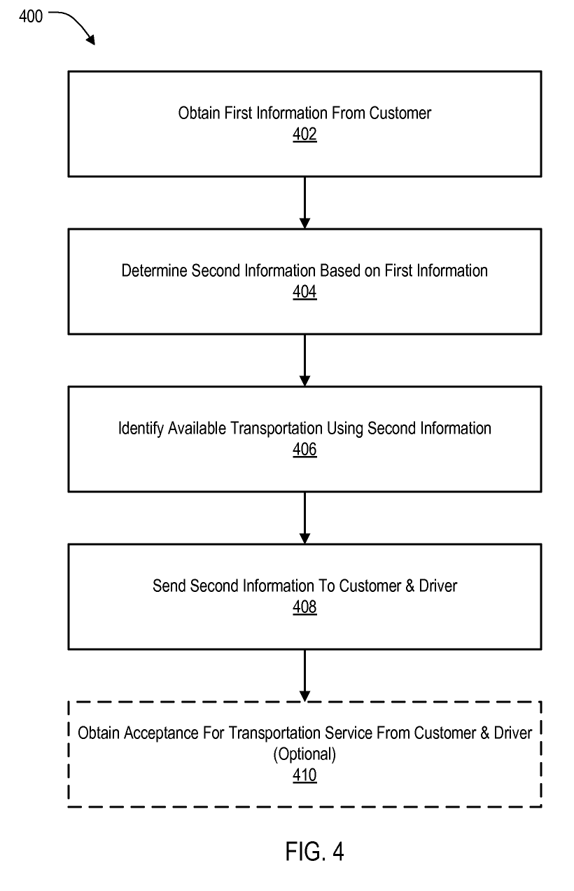

FIG. 4 is a flow diagram of an example process 400 performed by a transportation service for matching customers with available transportation. In some implementations, the process 400 can begin when the transportation service obtains information from a device (402). The information can include an ID (e.g., a customer ID, MSID, SIM SN, ICC-ID), position information, destination information, password, encryption key, and any other information that can be used by the transportation service to deliver services to customers.

The transportation service can determine a second set of information based on the information obtained from the device (404). For example, the transportation service can determine a route to the destination, a travel time estimate and an optional bid based on the information received from the device.

Once the second set of information is determined (e.g., a route and customer location is determined), the transportation service can use the second set of information to identify available transportation proximate to the customer (406). For example, the service can determine the closest available transportation by tracking the position of each vehicle in its fleet and computing a distance to the customer and/or other considerations (e.g., traffic, user preferences). The second set of information (e.g., route, map data, travel time estimate, fare estimate and an optional bid) can be sent to the customer's device and to the driver over the network connection (408). The second set of information can be displayed to the customer on a display of the device and on a navigation display in the vehicle, as described in reference to FIG. 5. If a bid was sent the transportation service can start an customer acceptance window timer and wait for a bid acceptance from the customer, and optionally a confirmation from the driver that the driver will provide the service for the customer for the bid price (410). Once the driver provides a confirmation that the service will be performed for the bid price, the transportation service can notify the customer that their request has been received, and optionally provide the customer with an estimated time of arrival (ETA) for the driver.

In some implementations, once a driver has been assigned to a customer, the transportation service provider can provide updates to the driver and other third parties (e.g., a transit authority), so that both parties have relevant data if the customer is missed or the customer chooses to take other transportation. This data allows the provider to reschedule a pick-up and, if the customer is a subscriber, debit the customer's account accordingly.

Thus the foregoing features empower customers to manage their transportation needs using a mobile device, so that the customer can avoid competing for transportation on street corners or relying on overworked or inattentive hotel valets to arrange for transportation. Moreover, the foregoing features allow a transportation service provider to efficiently dispatch available transportation to customers in realtime based on user preferences, and provide a map with the shortest route to the destination.

The optional bidding process allows transportation service providers to bid on fares which can promote healthy competition among providers which may benefit the customer in the form of lower fares. In some implementations, an estimated or fixed fare amount can be sent to the customer instead of a bid so that the user knows the exact or an approximate cost for the transportation. The user can then accept the bid of fare so that the bid or fare can be automatically deducted from the customer's account, if the customer is a subscriber to the transportation service. Providing the customer with the bid or fare before the service is rendered can help prevent price gouging by drivers since the bid or fare is agreed upon in advance. The transportation services can employ or contract with independent drivers for fixed fares and/or other revenue sharing agreements which can help independent drivers get steady work. Drivers have increased flexibility in choosing which fares to take through the confirmation process or by allowing the time window for bid acceptance to expire without providing a confirmation. This feature allows the drivers to pick and choose customers to maximize their profits. Transportation service providers can monitor which drivers are the most productive and drop the poor performers and/or reward the top performers. Many other business models are possible.

### Example Map Display For Presentation To Customers

FIG. 5 illustrates an example display 500 presented to a customer in accordance with the process 200 of FIG. 2. The display can be the display 112 of device 100 or a display of mobile device 132, for example. The display 500 can include a map 502 showing a route 508 from the customer's current location 504 to the customer's desired destination 506. The display 500 can include one or more bids 510 from transportation services to carry the customer from their current location 504 to the destination 506 using route 508. In the example shown, the customer received two bids: a first bid from Yellow Cab for $15 and a second bid from Checker Cab for $20.00. In this scenario, the customer accepted Yellow Cab's lower bid by checking a box next to the bid and touching the Accept button 512. In some implementations, the display 500 can include one or more display areas 514 for displaying ads and/or other content (e.g., video). Additionally, audio content can also be provided.

### Example Map Display For Presentation To Customers

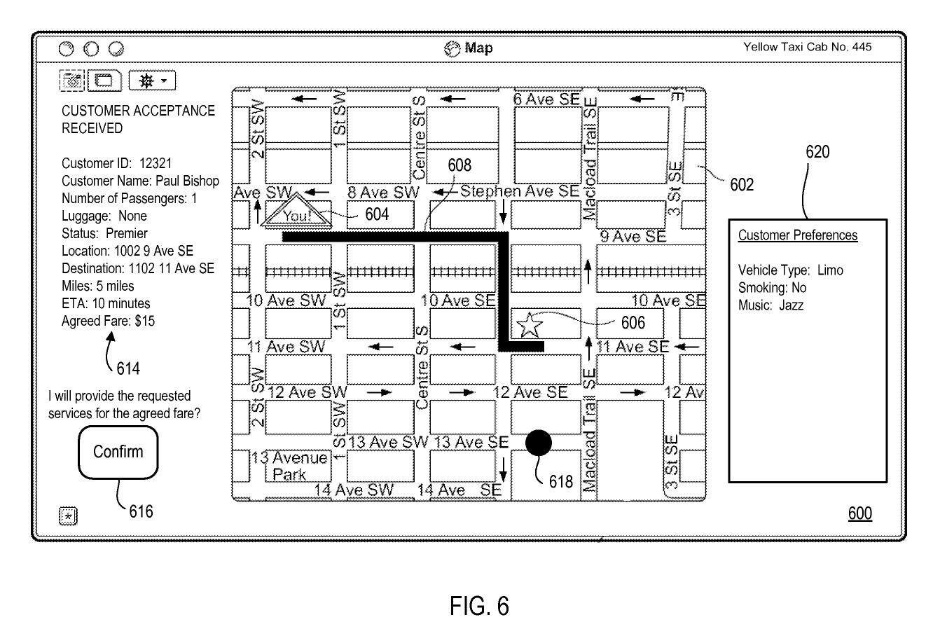

FIG. 6 illustrates an example display 600 presented to a driver in accordance with the process of FIG. 4. The display 600 can be a display of a navigation system, for example. The display 600 can include a map 602 (similar to map 502) showing a route 608 from the customer's current location 604 to the customer's desired destination 606. The display 600 can also show the location 618 of the driver's vehicle. In the example shown, the display 600 also presents customer data 614 which can describe the customer and navigation data. An ETA for the driver to arrive at the pick-up location can be displayed, together with the length of the route. The bid or fare agreed upon can also be displayed.

The driver can confirm the bid or fare acceptance by clicking or touching the Confirm button 616. Other information can also be shown on display 600, including but not limited to customer preferences 620, alternate routes, traffic reports, weather reports, road closures, customer requests, number of passengers, and any other information that would be useful to the driver.

### Example Mobile Device Architecture

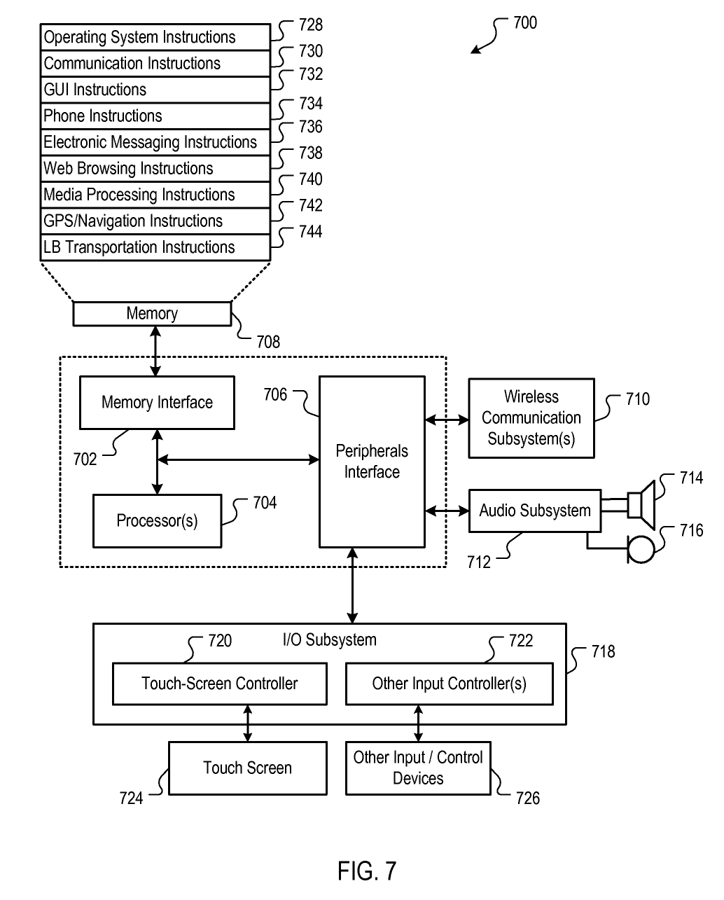

FIG. 7 is a schematic diagram of an example mobile device 700 for providing the features and performing the processes described in reference to FIGS. 1-6. The mobile device 700 can include a memory interface 702, one or more processors 704 and a peripherals interface 706. The memory interface 702, the one or more processors 704 and/or the peripherals interface 706 can be separate components or can be integrated in one or more integrated circuits. The various components in the mobile device 700 can be coupled by one or more communication buses or signal lines.

Sensors, devices and subsystems can be coupled to the peripherals interface 706 to facilitate multiple functionalities. For example, communication functions can be facilitated through one or more wireless communication subsystems 710, which can include radio frequency receivers and transmitters and/or optical (e.g., infrared) receivers and transmitters. The specific design and implementation of the communication subsystem 710 can depend on the communication network(s) over which the mobile device 700 is intended to operate. For example, a mobile device 700 may include communication subsystems 710 designed to operate over a GSM network, a GPRS network, an EDGE network, a Wi-Fi or WiMax network, and a Bluetooth™network. In particular, the wireless communication subsystems 710 may include hosting protocols such that the mobile device 700 may be configured as a base station for other wireless devices.

An audio subsystem 712 can be coupled to a speaker 714 and a microphone 716 to facilitate voice-enabled functions, such as voice recognition, voice replication, digital recording, and telephony functions.

The I/O subsystem 718 can include a touch screen controller 720 and/or other input controller(s) 722. The touch-screen controller 720 can be coupled to a touch screen 724. The touch screen 724 and touch screen controller 720 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 746.

The other input controller(s) 722 can be coupled to other input/control devices 726, such as one or more buttons, rocker switches, thumb-wheel, infrared port, USB port, and/or a pointer device such as a stylus. The one or more buttons (not shown) can include an up/down button for volume control of the speaker 714 and/or the microphone 716.

In one implementation, a pressing of the button for a first duration may disengage a lock of the touch screen 724; and a pressing of the button for a second duration that is longer than the first duration may turn power to the mobile device 700 on or off. The customer may be able to customize a functionality of one or more of the buttons. The touch screen 724 can, for example, also be used to implement virtual or soft buttons and/or a keypad or keyboard.

In some implementations, the mobile device 700 can present recorded audio and/or video files, such as MP3, AAC, and MPEG files. In some implementations, the mobile device 700 can include the functionality of a media player. The mobile device 700 may, therefore, include one or more n-pin (e.g., 32 pin) connectors that are compatible with a media player. Other input/output and control devices can also be used.

The memory interface 702 can be coupled to memory 708. The memory 708 can include high-speed random access memory and/or non-volatile memory, such as one or more magnetic disk storage devices, one or more optical storage devices, and/or flash memory (e.g., NAND, NOR). The memory 708 can store an operating system 728, such as Darwin, RTXC, LINUX, UNIX, OS X, WINDOWS, or an embedded operating system such as VxWorks. The operating system 728 may include instructions for handling basic system services and for performing hardware dependent tasks.

The memory 708 may also store communication instructions 730 to facilitate communicating with one or more additional devices, one or more computers and/or one or more servers. The memory 708 may include graphical customer interface instructions 732 to facilitate graphic customer interface processing; phone instructions 734 to facilitate phone-related processes and functions; electronic messaging instructions 736 to facilitate electronic-messaging related processes and functions; web browsing instructions 738 to facilitate web browsing-related processes and functions; media processing instructions 740 to facilitate media processing-related processes and functions; GPS/Navigation instructions 742 to facilitate GPS and navigation-related processes and instructions; and location based transportation instructions 744 for implementing operations and features described in reference to FIGS. 1-6.

Each of the above identified instructions and applications can correspond to a set of instructions for performing one or more functions described above. These instructions need not be implemented as separate software programs, procedures or modules. The memory 708 can include additional instructions or fewer instructions. Furthermore, various functions of the mobile device 700 may be implemented in hardware and/or in software, including in one or more signal processing and/or application specific integrated circuits.

The features described can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a customer, the features can be implemented on a computer having a display device such as a CRT (cathode ray tube) or LCD (liquid crystal display) monitor for displaying information to the customer and a keyboard and a pointing device such as a mouse or a trackball by which the customer can provide input to the computer.

The features can be implemented in a computer system that includes a back-end component, such as a data server, or that includes a middleware component, such as an application server or an Internet server, or that includes a front-end component, such as a client computer having a graphical customer interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
obtaining first information relating to a request for transportation services, where the first information includes at least a location of a device used to make the request and a destination;
determining second information from the first information, the second information including at least a route;
determining available transportation for delivering the requested transportation service using the second information; and
sending the second information to the device and to the available transportation.

2. A method comprising:
communicating a request for transportation services to one or more transportation service providers using a device, including first information related to the request, the first information identifying a location of the device and a destination;
receiving second information including a plurality of bids from the one or more transportation services related to providing at least some of the requested transportation services;
obtaining input specifying a bid acceptance; and
transmitting the bid acceptance to the one or more transportation service providers.
